(19) United States
(12) Patent Application Publication
(10) Pub. No.: US 2020/0393066 A1
(43) Pub. Date: Dec. 17, 2020

(54) COUPLING DEVICE AND A METHOD OF USING A COUPLING DEVICE

(71) Applicant: Glenn BROWN, Spring, TX (US)

(72) Inventor: Glenn BROWN, Spring, TX (US)

(21) Appl. No.: 16/438,173

(22) Filed: Jun. 11, 2019

(51) Int. Cl. F16L 21/06

(52) U.S. Cl. CPC F16L 21/065

(57) ABSTRACT

A coupling device configured with at least one fastener for compressing and also opening the coupling and a pushing bolt configured to apply an unlocking force on an object to be coupled by the coupling device. A method for engaging and disengaging a coupling device is disclosed herein.

### TECHNICAL FIELD

The present disclosure relates to a mechanical coupling, and in particular, a coupling device configured to open and close mechanically with a pushing bolt configured to apply an unlocking force to a coupled object.

### BACKGROUND

The present invention relates to couplings for attaching various mechanical devices, such as hoses, manifolds, and similar connections. More particularly, the present invention pertains to a coupling that includes at least one fastener configured to open the coupling and at least one pushing bolt configured to apply an unlocking force.

Previously, conventional compression couplings were configured only to connect two or more separate devices (e.g., hose, manifold, etc.) together. The compression coupling came in at least two parts which fit around the connection areas (e.g., shaft, neck, etc.) of the two devices being coupled. On many applications such as industrial applications and cryogenic applications, the prior art compression couplings effectively coupled; however, they often become seized together with the devices they coupled, thus making it difficult for operators to decouple the separate devices.

### SUMMARY

The present invention, as described herein, addresses the problems described above and other problems of prior art systems and methods which will become apparent to one skilled in the art from the description below.

In some aspects, a coupling comprises a first coupling section, a second coupling section, the first and second coupling sections forming an aperture, a threaded bore formed in and extending through the second coupling into the aperture; and a pushing bolt configured to engage the threaded bore of the second coupling and extend through the threaded bore and into the aperture formed by the first and second coupling sections to apply an unlocking force on an object positioned inside the aperture. In some aspects, the coupling device further comprises a first fastener configured to engage a second threaded bore formed in the second coupling section and move the first coupling section and the second coupling section towards each other when a closing force is applied to the first fastener. In some aspects, the unlocking force is applied to the object positioned inside the aperture in a threaded region of the second coupling section. In some aspects, the pushing bolt is configured to extend into the aperture beyond an inner surface of the second coupling section a predetermined distance.

In some aspects, the coupling further comprises a first contact surface formed on the first coupling section, a second contact surface formed on the second coupling section, a stepped bore formed in the first coupling section, the stepped bore being coaxial with the second threaded bore of the second coupling section, a first section formed in the stepped bore, the first section having a first diameter, and a second section formed in the stepped bore, the second section having a second diameter. In some aspects, the first fastener is situated inside the stepped bore.

In some aspects, the first contact surface and the second contact surface of the coupling directly contact each other when the closing force is applied to the first fastener, and the first contact surface and the second contact surface separate from each other when the opening force is applied to the first fastener. In some aspects, the closing force is applied to the first fastener in a first direction; the opening force is applied to the first fastener in a second direction; the first section and the second section are coaxial; and the diameter of the second section is greater than a diameter of the first section. In some aspects, a snap ring is attached to the first fastener, the snap ring having a diameter larger than the diameter of the first section of the stepped bore. In some aspects, the first fastener is a jack screw.

In some aspects, a method of mechanically decoupling a first mechanical device from a second mechanical device uses a coupling device, the method comprising applying a loosening force to an unlocking bolt of a coupling device; applying an unlocking force to a pushing bolt of the coupling device, the unlocking force being applied by an operator; determining whether the coupling device can be removed from the first and second mechanical devices by hand operation; applying a second unlocking force to the pushing bolt based on the determining whether the coupling device can be removed from the first and second mechanical devices by hand operation; and decoupling the first and second mechanical devices by rotating the coupling device by hand operation.

Any embodiment of any of the disclosed compositions and/or methods can consist of or consist essentially of—rather than comprise/include/contain/have—any of the 16 described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb.

The term “substantially” and its variations are defined as being largely but not necessarily wholly what is specified as understood by one of ordinary skill in the art, and in one non-limiting embodiment substantially refers to ranges within 10%, within 5%, within 1%, or within 0.5%.

The term “about” or “approximately” or “substantially unchanged” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” in the claims and/or the specification may mean “one,” but it is also consistent with the meaning of “one or more,” “at least one,” and “one or more than one.”

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the disclosed system and methods, reference is now made to the following descriptions taken in conjunction with the accompanying drawings.

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1 is a perspective view of a coupling, according to one example embodiment of the present invention.

FIG. 2 is a front view of a coupling, according to one example embodiment of the present invention.

FIG. 3 is a side view of a coupling, according to one example embodiment of the present invention.

FIGS. 4A and 4B are a top and bottom view, respectively, of an exemplary coupling section, according to one example embodiment of the present invention.

FIG. 5 is a cross section of a coupling, according to one example embodiment of the present invention.

FIG. 6 is a coupling with various fasteners, according to one example embodiment of the present invention.

FIG. 7 is a coupling with various fasteners, according to one example embodiment of the present invention.

FIG. 8 is a coupling with various fasteners, according to one example embodiment of the present invention.

FIGS. 9A-9D are coupling sections, according to one example embodiment of the present invention.

FIGS. 10A and 10B are coupling sections, according to one example embodiment of the present invention.

FIG. 11 is a flowchart of a method of engaging a coupling, according to one example embodiment of the present invention.

FIG. 12 is a flow chart of a method of disengaging a coupling, according to one example embodiment of the present invention.

### DETAILED DESCRIPTION

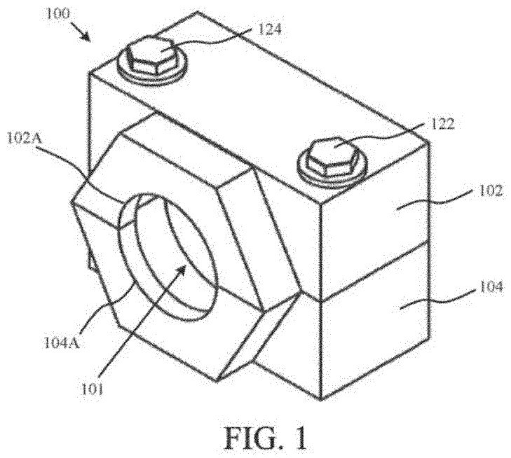

Various embodiments of the coupling shall be described with reference to FIGS. 1-8. The particular features of the disclosed embodiments should not be limited to just those illustrated configurations. Instead, the various features disclosed within this disclosure may be combined to create exponentially more embodiments not explicitly illustrated within this disclosure. As one example, the various fasteners and configurations for opening and closing the clamshell coupling which are disclosed within may be combined in far more configurations than illustrated within the confines of this disclosure.

In the following description, numerous specific details are provided to provide a thorough understanding of the disclosed embodiments. One of ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

FIG. 1 shows a perspective view of a coupling 100, according to an exemplary embodiment of the present invention. In many embodiments, and as illustrated in FIG. 1, coupling 100 includes two separable sections, 102 and 104. Coupling 100 may include sections held together by various fasteners, such as a hinge(s) (e.g., 224, 324, etc.) and/or unlocking bolt(s) (e.g., 122, 124, etc.). For example, and as shown in the illustrated embodiment of FIG. 1, coupling 100 is connected by jack screws, 122 and 124 (jack screw and locking/unlocking bolt may be used interchangeably). Coupling 100 includes an aperture 101 configured to surround the two or more components (e.g., fittings) that are being coupled. In many embodiments, the aperture 101 has a circular circumference configured to mirror the circumference of the components being fitted. It should be understood that the shape of aperture 101 may be adapted to fit the particular shape of the components being coupled (e.g., hexagon, etc.). As shown by 102A and 104A, aperture 101 is divided between sections 102 and 104.

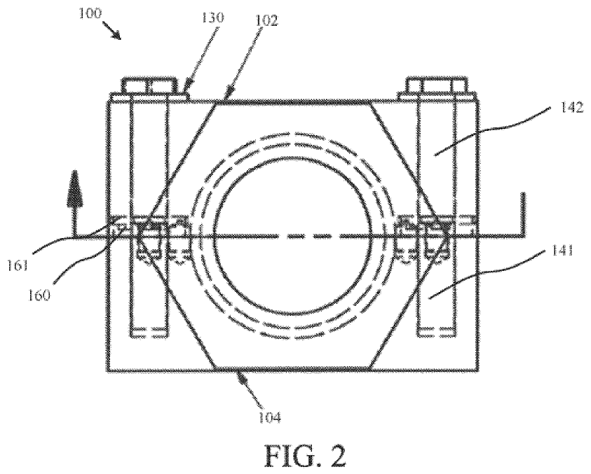

FIG. 2 shows a front view of a coupling 100, according to one embodiment of the present invention. Sections 102 and 104 may include one or more bore(s) (e.g., 141 and 142) configured to accommodate a fastener, such as a jack screw. In order to couple, sections 102 and 104 fit together to create a coupling assembly that completes the circumference of aperture 101. Fasteners such as 122 and 124 may incorporate a washer(s) 130. The fasteners (e.g., 122 and/or 124) may be held in place with a snap ring (e.g., 160). In some configurations, snap ring 160 prevents the jack screw 122 or 124 from becoming separated from section 102. It should be understood that various alternatives exist for snap ring 160, such as a sleeve which covers a larger portion of fastener 122 and/or 124. In conjunction with the fastener(s), snap ring 160 may assist in separating section 102 from section 104 (i.e., opening the coupling). In many embodiments, the coupling 100 has an unthreaded bore 142 in section 102 but has a threaded bore 141 in section 104. In this configuration, rotating the fasteners 122 and 124 counterclockwise opens the coupling.

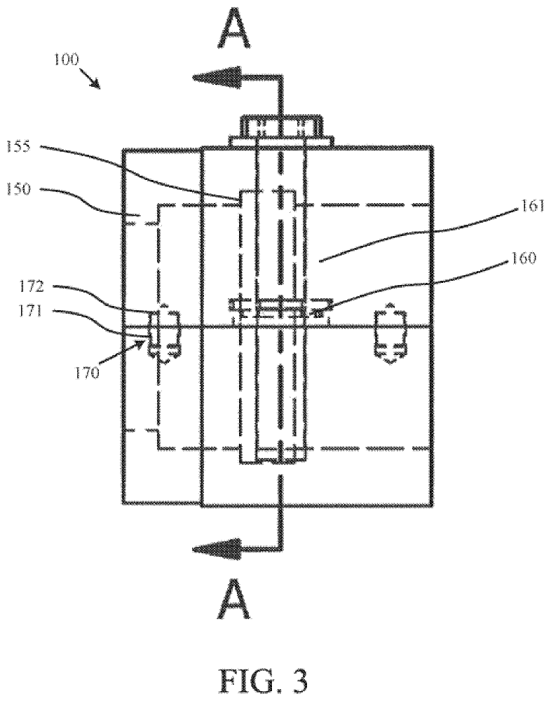

FIG. 3 shows a side view of a coupling 100, according to one example embodiment of the present invention. The aperture 101 of coupling 100 includes different apertures (e.g., 150 and 155) in order to prevent separation of the two or more fittings. Further, coupling 100 may include structures that align sections 102 and 104 together and also reduce the torsional strain on the fasteners. For example, section 104 may include alignment dowels 170, each with a protrusion 171 (“alignment dowel” or “male” portion) which fits into a similarly sized and shaped cavity 172 (“female” portion) in section 102. It typically does not matter which section has the male portion or corresponding female portion. Further, it should be understood that other structures may be used, such as a ridge on one section and corresponding valley on the other section, or further, a lip extending around the perimeter on one section which surrounds the perimeter of the other section (e.g., shoebox lid).

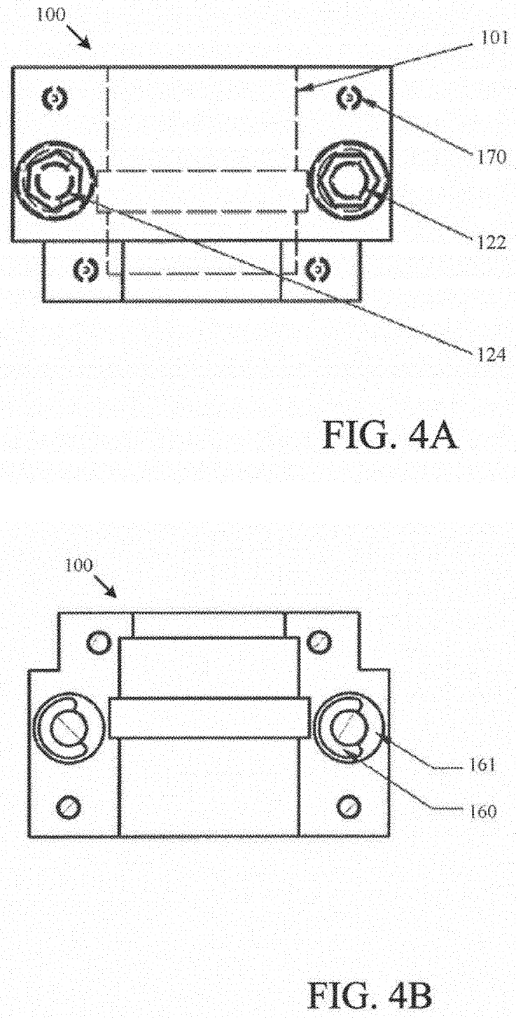

FIGS. 4A and 4B show a top and bottom view of an exemplary section 102, according to one example embodiment of the present invention. FIG. 4A shows a top view of an exemplary section 102. The fasteners 122 and 124 may be threaded per the specification and size required for a particular application. Alignment dowels 170 may be placed throughout the coupling to secure sections 102 and 104 together. For example, the illustrated embodiment includes four alignment dowels. The aperture 101 may be configured to accommodate the fittings it will be mating (e.g., 2.4-4 Stub ACME-2G-RH-INT to 2.4-4 Stub ACME-2-G-RH-EXT). FIG. 4B shows a bottom view of an exemplary section 102. The cross sectional view of FIG. 4B is identified in FIG. 2. In the illustrated embodiment, snap ring 161 prevents fasteners 122 and 124 from separating from section 102. Further, the connection of snap ring 161 with section 102 allows the coupling 100 to open mechanically when fasteners 122 and 124 are rotated, which is typically a counterclockwise rotation, but is dependent upon the direction of the threading of the fastener and the threaded bore.

FIG. 5 shows a cross section of a coupling 100, according to one example embodiment of the present invention. The cross sectional view of FIG. 5 is identified in FIG. 3 as the section line A-A. In embodiments with jack screws or similar fasteners, coupling 100 tightens one or more sealing surfaces together by linearly compressing one or more sealing surfaces against one or more corresponding sealing surfaces of at least one fitting (this may include sealing surfaces that use gaskets), which can be accomplished using a standard sized wrench. To open, coupling 100 loosens one or more sealing surfaces from one or more corresponding sealing surfaces of at least one fitting by moving apart section 102 and 104 from each other. When section 102 and 104 move apart, the tight bond of the male fitting and the coupling 100 is loosened (“broken loose”) without the use of a hammer or similar tool. In one embodiment, the coupling 100 is loosened and removed by untightening/loosening the fastener 122 and 124. This allows the coupling to be opened to varying positions and rotated by hand or with a wrench. This configuration allows the sealing surfaces to be disconnected from their corresponding fitting sealing surfaces. As such, the unsafe hammering to “break loose” the coupling when the transfer of fluid (or similar) is complete is no longer needed. Coupling 100 can be used in place of standard couplings on existing fittings, and as such, no retrofit of the existing delivery end or existing receiving end is necessary.

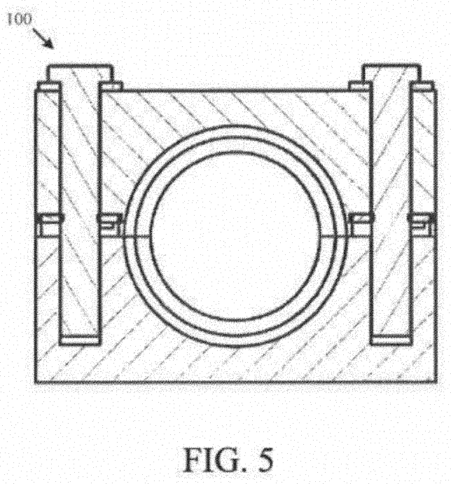

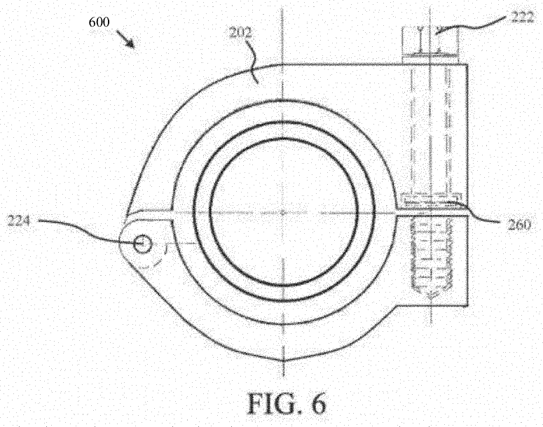

FIG. 6 shows a coupling 600 with a hinge fastener, according to one example embodiment of the present invention. It should be understood that some embodiments may use a pivot point (e.g., hinge, 224) in place of a jack screw (e.g., 124), as shown by the exemplary embodiment in FIG. 6. In such a configuration, jackscrew 222 is configured to open and close the clamshell coupling about the pivot point. Snap ring 260 secures fastener 222 to section 202. The bore of section 202 may be configured (e.g., enlarged) to accommodate for the arcuate opening direction of coupling 200. Alternatively, fastener 202 may use a pivoting attachment point attach to section 202, in which the attachment point pivots on an axis that is parallel with hinge 224 (e.g., a sleeve surrounding the jack screw that also includes an attachment pin with a pivot axis parallel to the hinge pivot axis). Alternatively, it should be understood that some embodiments may use one unitary section instead of two separable sections 202 and 204. For example, the coupling—or at least a portion of the coupling—may be created out of a metal, polymer, plastic, or other similar material that is sufficiently rigid to act as a coupling but yet pliable enough to open far enough to release the coupling, and as such, the coupling may use a single unlocking bolt but not require a hinge/pivot point.

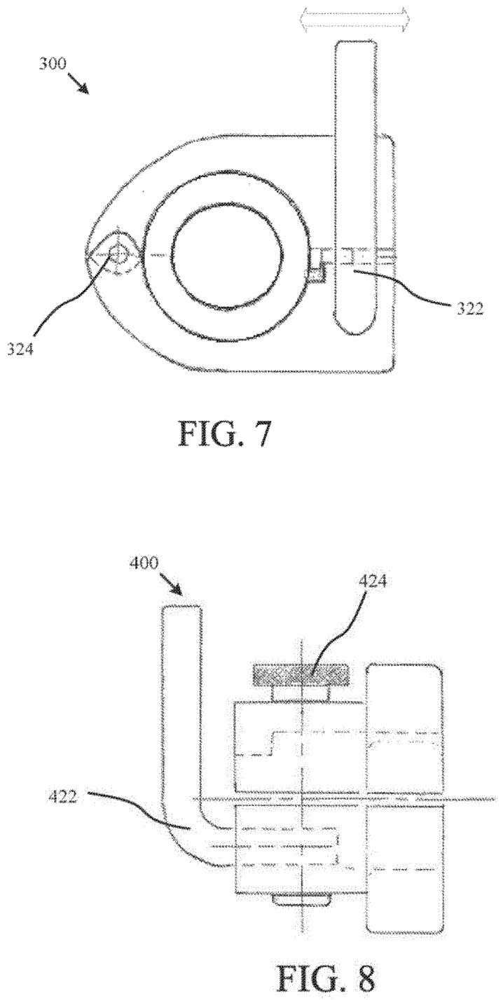

FIGS. 7 & 8 show couplings 300 and 400 with various fasteners, according to one example embodiment of the present invention. As additional examples of possible fasteners, couplings 300 and 400 include latch fasteners, 322 and 422, respectively. Coupling 300 includes a hinge 324 while coupling 400 includes a jack screw, 424. The latch fastener is configured to open and close by rotating, as shown by the arrow. An internal latch on the latch fastener locks the two sections together when rotated. An internal cam on the latch opens the two sections when rotated the other direction. The sections 304 and 404 are configured with a bore to accept the latch fasteners. Further, sections 304 and 404 may be configured with channels/recesses to accept the internal latch and internal cam.

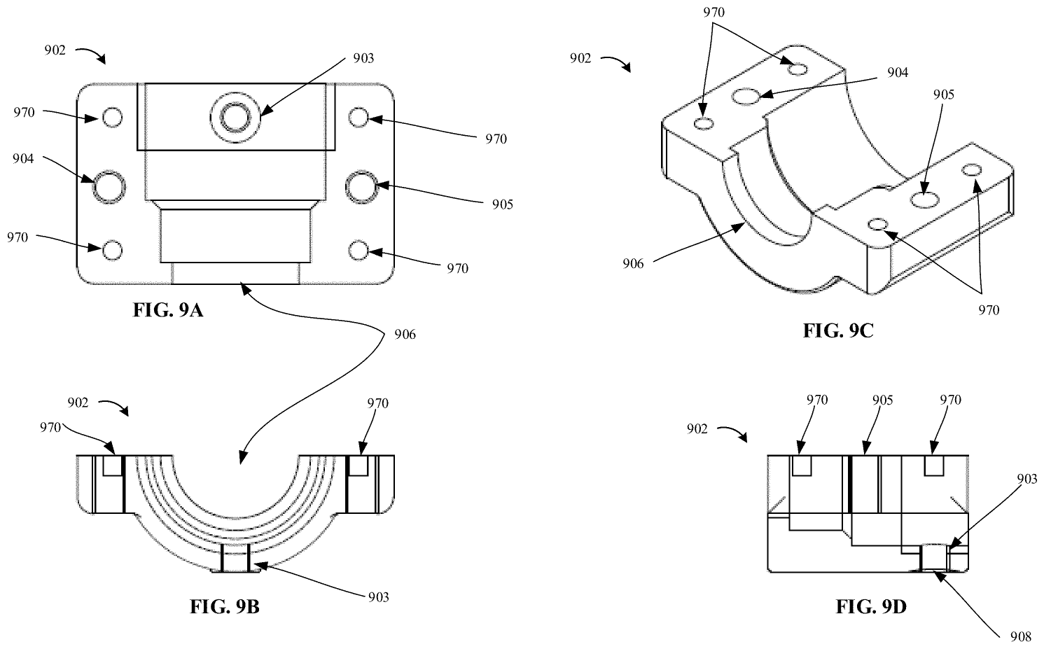

FIGS. 9A-9D show coupling section 902 with threaded bore 903 formed in coupling section 902. FIG. 9A shows a bottom view of coupling section 902; FIG. 9B shows a cross section view of coupling section 902; FIG. 9C shows a perspective view of coupling section 902; and FIG. 9D shows a side cross section view of coupling section 902. As shown in FIGS. 9A-9D, threaded bore 903 extends from an outer surface of coupling section 902 to an inner surface of coupling section 902. Coupling section 902 may also include threaded bores 904 and 905, which may be configured to receive fastening means to connect coupling section 902 to a second coupling section. Coupling section 902 may also include cavities 970, which may be configured to receive alignment dowels. Threaded bores 903, 904, and 905 may be positioned in the same direction, i.e., perpendicular to axis of aperture 906. Alternatively, threaded bore 903 may be positioned in a different direction than threaded bores 904 and 905. As shown in FIG. 9D, threaded bore 903 may have diameter 908.

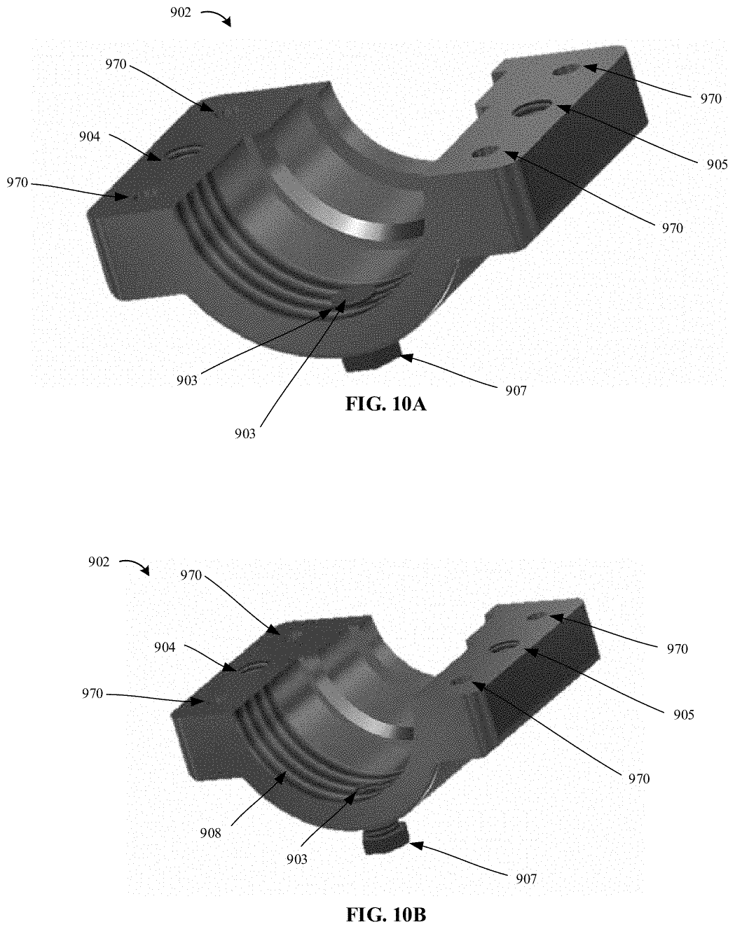

FIGS. 10A & 10B show perspective views of coupling section 902 with threaded bore 903 and pushing bolt 907. As shown in FIG. 10A, pushing bolt 907 is extended through threaded bore 903 and decoupling section 902 a predetermined distance 910 beyond the inner surface of coupling section 902, so that a pushing force may be applied to an object positioned inside aperture 906 via pushing bolt 907. As shown in FIG. 10B, pushing bolt 907 has been disengaged from aperture 906 and is in an opened position, so as not to apply a pushing force on an object positioned inside aperture 906. Pushing bolt 907 may be engaged and disengaged from exerting a force onto an object, for example, by applying a rotational force to pushing bolt 907.

As shown in FIGS. 10A & 10B, threaded bore 903 may be positioned in threaded region 908 of coupling section 902 so that the pushing force exerted by pushing bolt 907 is applied to a threaded portion of an object positioned inside aperture 906. Alternatively, threaded bore 903 may not be positioned in a threaded region 908 of coupling section 902.

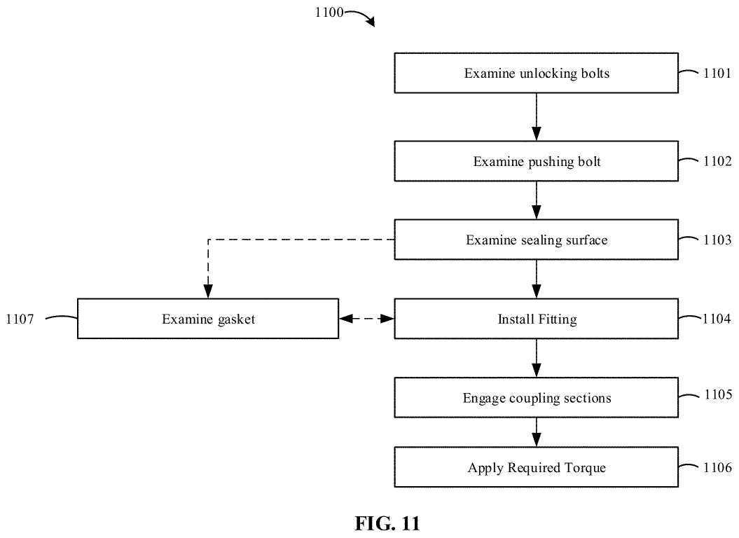

FIG. 11 depicts an exemplary method of engaging a coupling device. At step 1101, an operator may examine the tightness and position of an unlocking bolt of coupling device to determine (1) if the unlocking bolt is bottomed into its threaded bore; and/or (2) if the coupling device is in a fully closed position. If coupling device includes more than one unlocking bolt, then the operator may examine the tightness and position of any additional unlocking bolts to determine (1) if the additional unlocking bolt(s) are bottomed into its threaded bore; and/or (2) if the coupling device is in a fully closed position. At step 1102, the operator may examine the pushing bolt to determine if the pushing bolt is disengaged. At step 1103, the operator examines the coupling device to determine if the sealing surface is damaged. If the coupling device is coupling a gasket fitting, at step 1107, the operator ensures the gasket is in place and properly positioned. If the fitting does not have a gasket, step 1104 may follow step 1103. At step 1104, the operator installs a fitting to be coupled into the coupling device by manually pushing the sealing surfaces of the coupling device (either with a gasket or without a gasket) against each other so that the sealing surfaces are pushed against each other in the correct position.

At step 1105, the operator engages the coupling device by hand rotating the coupling device around the fitting to be coupled in either a clockwise direction or a counterclockwise direction. For example, coupling device may be rotated around a fitting to be coupled to a minimum of hand tightness.

At step 1106, after the coupling device has been engaged by hand tightness, the operator may then apply additional torque by means of a tool, e.g., wrench, etc., so as to reach a threshold torque value.

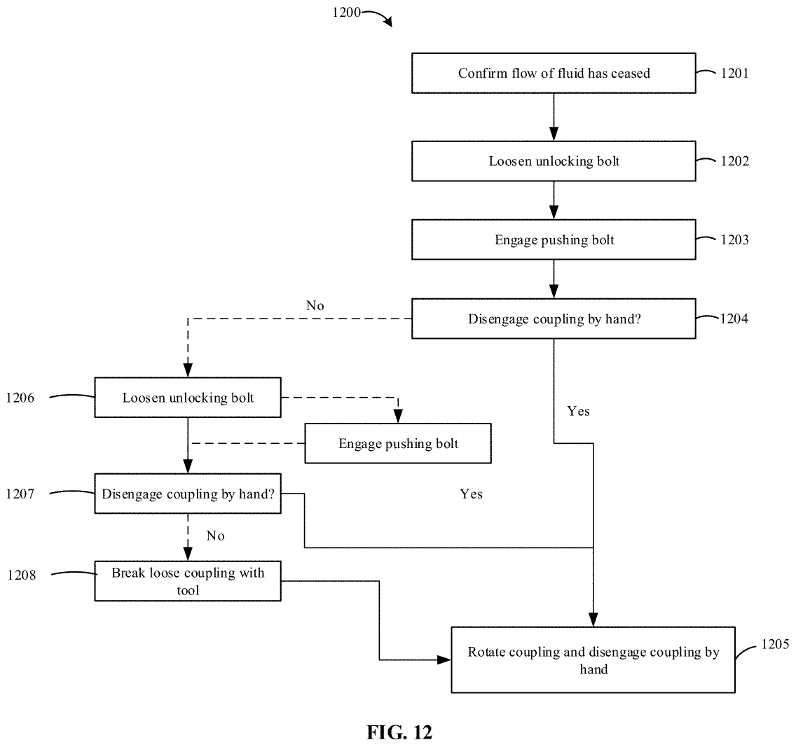

FIG. 12 depicts an exemplary method of disengaging a coupling device. At step 1201, an operator may confirm the flow of fluid through a fitting has ceased. At step 1202, the operator may loosen the unlocking bolt. If the coupling device includes more than one unlocking bolt, the operator may loosen the additional unlocking bolt(s). For example, an operator may loosen an unlocking bolt by rotating the unlocking bolt two complete turns. At step 1203, the operator may engage pushing bolt. For example, operator may rotate pushing bolt one complete turn inwards towards the fitting. At step 1204, the operator may attempt to disengage the coupling device by applying a force without the use of a tool (i.e., by hand). If, at step 1204, the operator is able to remove the coupling device without the use of a tool, then the operator may proceed to step 1205, at which the operator disengages the coupling device from the fitting with the use of a tool (i.e., by hand). In this manner, an operator may safely disengage a coupling device and separate two mechanical devices without using a large force to separate the coupling device (i.e., without the use of a wrench or hammer to “break lose” the mechanical devices). Using such large forces significantly increases the chance of the operator injuring him/herself, damaging the coupling devices, and/or damaging the mechanical devices being coupled. Avoiding these large forces protects both the operator and the mechanical components.

If the operator is unable to disengage coupling device, then at step 1206, the operator may loosen the unlocking bolt again by rotating the unlocking bolt one complete turn. Alternatively or in addition to step 1206, the operator may engage pushing bolt again by rotating pushing bolt one complete turn inwards towards the fitting. At step 1207, operator may attempt to disengage the coupling device again by applying a force without the use of a tool (i.e., by hand). If the operator is unable to disengage coupling device, then at step 1208, the operator may use a tool (e.g., a wrench) to rotate the coupling device until the coupling device becomes loose enough to rotate by hand. At step 1205, the operator removes coupling device from fitting by hand.

Although the present disclosure and its advantages have been described in detail, it should be understood that various changes, substitutions and alterations can be made herein without departing from the spirit and scope of the disclosure as defined by the appended claims. It should be noted that any of the various feature(s) disclosed in the detailed description may be excluded from any one of the various embodiments (i.e., a negative limitation of a particular feature) for the purpose of reducing cost, reducing complexity, increasing breathability, distinguishing from other methods and/or systems, and/or removing duplicative features that may be provided by a separate method or system, especially when the other method or system is connected with the present method and/or system. Further, various industries will require different combinations of the various features of the disclosed invention, and in particular, may need to limit or exclude certain features (i.e., a negative limitation of a various feature). Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A coupling, comprising:
a first coupling section;
a second coupling section, the first and second coupling sections forming an aperture;
a threaded bore formed in and extending through the second coupling into the aperture; and
a pushing bolt configured to:
engage the threaded bore of the second coupling; and
extend through the threaded bore and into the aperture formed by the first and second coupling sections to apply an unlocking force on an object positioned inside the aperture.

2. The coupling of claim 1, further comprising:
a first fastener configured to:
engage a second threaded bore formed in the second coupling section;
move the first coupling section and the second coupling section towards each other when a closing force is applied to the first fastener.

3. The coupling of claim 1, wherein the unlocking force is applied to the object positioned inside the aperture in a threaded region of the second coupling section.

4. The coupling of claim 1, wherein the pushing bolt is configured to extend into the aperture beyond an inner surface of the second coupling section a predetermined distance

5. The coupling of claim 2, further comprising a second fastener.

6. The coupling of claim 1, further comprising a hinge.

7. The coupling of claim 2, further comprising a hinge.

8. The coupling of claim 2, wherein the first fastener is a jack screw.

9. The coupling of claim 2, further comprising:
a first contact surface formed on the first coupling section;
a second contact surface formed on the second coupling section;
a stepped bore formed in the first coupling section, the stepped bore being coaxial with the second threaded bore of the second coupling section; wherein the first fastener is situated inside the stepped bore;
a first section formed in the stepped bore, the first section having a first diameter; and
a second section formed in the stepped bore, the second section having a second diameter.

10. The coupling of claim 9 wherein:
the first contact surface and the second contact surface directly contact each other when the closing force is applied to the first fastener;
the first contact surface and the second contact surface separate from each other when the opening force is applied to the first fastener;
the closing force is applied to the first fastener in a first direction;
the opening force is applied to the first fastener in a second direction;
the first section and the second section are coaxial; and
the diameter of the second section is greater than a diameter of the first section.

11. The coupling of claim 10 further comprising:
a snap ring attached to the first fastener, the snap ring having a diameter larger than the diameter of the first section of the stepped bore.

12. A method of mechanically decoupling a first mechanical device from a second mechanical device using a coupling device, the method comprising:
(a) applying a loosening force to an unlocking bolt of a coupling device;
(b) applying an unlocking force to a pushing bolt of the coupling device, the unlocking force being applied by an operator;
(c) determining whether the coupling device can be removed from the first and second mechanical devices by hand operation;
(d) applying a second unlocking force to the pushing bolt based on the determining whether the coupling device can be removed from the first and second mechanical devices by hand operation;
(e) decoupling the first and second mechanical devices by rotating the coupling device by hand operation.

13. The method of claim 12, wherein the coupling device includes:
a first coupling section;
a second coupling section, the first and second coupling sections forming an aperture; and
a threaded bore formed in and extending through the second coupling into the aperture; wherein the pushing bolt is configured to:
engage the threaded bore of the second coupling; and
extend through the threaded bore and into the aperture formed by the first and second coupling section to apply the unlocking force on at least one of the first and second mechanical objects positioned inside the aperture.

14. The method of claim 13, wherein the coupling device includes:
a first fastener configured to:
engage a second threaded bore formed in the second coupling section;
move the first coupling section and the second coupling section towards each other when a closing force is applied to the first fastener.

15. The method of claim 12, wherein the unlocking force is applied to at least one of the first and second mechanical objects positioned inside a threaded region of the second coupling section.

16. The method of claim 13, wherein the pushing bolt is configured to extend into the aperture of the coupling device a predetermined distance.

17. The method of claim 14, wherein the first fastener is a jack screw.
